(19) United States
(12) Patent Application Publication
(10) Pub. No.: US 2012/0314061 A1
(43) Pub. Date: Dec. 13, 2012

(54) IMAGING APPARATUS, IMAGING METHOD, PROGRAM, AND INTEGRATED CIRCUIT

(76) Inventor: Shunsuke Yasugi, Osaka (JP)

(21) Appl. No.: 13/574,079

(22) PCT Filed: Nov. 18, 2011
(86) PCT No.: PCT/JP2011/006420

§ 371 Date: Jul. 19, 2012

(30) Foreign Application Priority Data
Nov. 24, 2010 (JP) 2010-260859

(51) Int. Cl. H04N 7/18

(52) U.S. Cl. 348/135; 348/E07.085

(57) ABSTRACT

Ambiguous distinction of PSFs between positions in front of and behind an imaging point corresponding to a distance to an object is eliminated without decreasing the amount of light to be exposed, and the distance to the object is estimated from a small number of captured images. An imaging apparatus includes: an imaging device which captures an image; an optical system for forming an image of an object on the imaging device; a birefringent substance having a birefringence effect; and a distance measurement unit which measures a distance from the imaging device to the object, using the captured image and a point spread function having a form changed by the optical element between positions in front of and behind an image point corresponding to the distance to the object.

### TECHNICAL FIELD

The present invention relates to an imaging apparatus for measuring a depth of a scene using a plurality of images captured from a single viewpoint.

### BACKGROUND ART

Conventionally, various methods have been suggested for measuring, without contact, a depth of a three-dimensional scene, that is, a distance from the imaging apparatus to each object (hereinafter, referred to as an “object distance”). Such methods can be largely classified into an active technique and a passive technique. The active technique is to irradiate the object with infrared rays, ultrasound, or laser, and calculate the object distance based on a length of time until a wave which is reflected returns or an angle of the reflected wave. The passive technique is to calculate the object distance based on an image of the object. In particular, in the case of using an imaging apparatus such as a camera to measure the object distance, the passive technique which does not require an apparatus for emitting infrared rays and so on is widely used.

Various passive techniques have been suggested, one of which is referred to as Depth from Defocus (hereinafter, referred to as “DFD”). The DFD is a distance measuring technique based on a blur changing its size and form depending on the object distance. The DFD has features such as not requiring a plurality of cameras, allowing distance measurement using a small number of images, and so on.

Hereinafter, a principle of the DFD is briefly described.

A captured image including a blur (hereinafter, referred to as a “blurred image”) is an image obtained by convoluting a Point Spread Function (PSF), which is a function of the object distance, into an all-in-focus image which represents a state without a lens-derived blur. Since the PSF is the function of the object distance, the object distance can be determined with the DFD by detecting the blur in the blurred image. However, at this time, the all-in-focus image and the object distance are unknown. One mathematical expression concerning the blurred image, the all-in-focus image, and the object distance is established for a single blurred image, and therefore a new mathematical expression is obtained when a new blurred image having a different focal position is captured. That is, a plurality of the above expressions are obtained corresponding to the respective blurred images each having a different focal position. The object distance is calculated by solving the expressions obtained as described above. Various methods for obtaining and solving the expressions have been suggested for the DFD, for example, Patent Literature (PL) 1 and Non-Patent Literature (NPL) 1.

The DFD is a technique to determine the object distance by using the PSF for the blur included in the blurred image. However, in the DFD, the forms of the PSFs are similar between positions in front of and behind the image point corresponding to the object distance. Therefore, the DFD has a problem in that it is ambiguous whether a PSF is one that is behind the image point or one that is in front of the image point, due to the influence of a noise included in the image, thereby making the distinction between those PSFs difficult.

To solve this problem, for example, increasing the number of images each having a different focal position can improve the accuracy rate of the estimation of the object distance. In addition, as in NPL 1, using apertures having a non point-symmetry shape as a whole can avoid the ambiguous distinction of the forms of the PSFs between positions in front of and behind the image point corresponding to the object distance.

### CITATION LIST

### Patent Literature

[PTL 1] Japanese Patent Gazette No. 2963990

### Non Patent Literature

[NPL 1] C. Zhou, S. Lin and S. Nayar, “Coded Aperture Pairs for Depth from Defocus” In International Conference on Computer Vision, 2009
[NPL 2] “Flexible Depth of Field Photography”, H. Nagahara, S. Kuthirummal, C. Zhou, S. K. Nayer, European Conference on Computer Vision, 2008

### SUMMARY OF INVENTION

### Technical Problem

Exemplary solutions to the problems concerning the ambiguous distinction of the forms of the PSFs between positions in front of and behind the image point corresponding to the object distance are given above, and the exemplary solutions are: the method of increasing the number of the images each having a different focal position; and the method of using apertures having a non point-symmetry shape as a whole. However, the former method has a problem of increasing the capturing time due to the increase in number of images. In addition, the latter method has a problem in that the light is shielded by a part of the apertures and thus the amount of light decreases, thereby degrading the estimation accuracy of the object distance.

The present invention is conceived in view of the above problems, and an object of the present invention is to provide an imaging apparatus which eliminates the ambiguous distinction of the forms of the PSFs between positions in front of and behind the image point corresponding to the object distance without decreasing the amount of light to be exposed, and estimates the object distance from a small number of captured images.

### Solution to Problem

To achieve the object described above, an imaging apparatus according to an aspect of the present invention includes: an imaging device which captures an image; an optical system for forming an image of an object on the imaging device; an optical element having a birefringence effect; and a distance measurement unit which measures a distance from the imaging device to the object, using the captured image and a point spread function having a form changed by the optical element between positions in front of and behind an image point corresponding to the distance to the object.

This configuration makes it possible to change the form of the point spread function (PSF) between the positions in front of and behind the image point corresponding to the object distance by using the optical element having the birefringence effect. This configuration allows elimination of the ambiguous distinction of the PSFs between positions in front of and behind the image point corresponding to the object distance, thereby allowing estimation of the object distance from a small number of captured images. Moreover, the decrease in the amount of light can be prevented in the case of using the birefringent substance because shielding light is unnecessary, compared to the method of using non point-symmetric apertures.

The optical element having the birefringence effect only affects astigmatism in general (especially when the birefringent substance is a parallel plate and the optical system is a telecentric optical system), unlike other optical elements. Therefore, even when the form of the PSF is changed between the positions in front of and behind the image point corresponding to the object distance, a small effect is given on other aberrations. Therefore, the optical system does not need to be re-designed. That is, the present invention can be achieved by only adding the optical element to a currently available apparatus which calculates the PSF.

Here, it is preferable that the optical element has an optic axis of which a direction is not parallel to a light axis of the optical system.

Here, it is preferable that the optical element is placed between the imaging device and the optical system on the light axis of the optical system, and a plane of the optical element which intersects with the light axis of the optical system is perpendicular to the light axis of the optical system.

Here, it is preferable to further include an optical element moving unit which turns on or off the birefringence effect on the light axis of the optical system by inserting or retracting the optical element with respect to the light axis of the optical system, in which the distance measurement unit measures the distance from the imaging device to the object, using an image captured by the imaging device without the birefringence effect of the optical element and using an image captured with the optical element placed on the light axis of the optical system.

Here, it is preferable that the optical element turns on or off the birefringence effect electrically or magnetically, and the distance measurement unit measures the distance to the object, using the image captured by the imaging device without the birefringence effect of the optical element and using an image captured with the optical element placed on the light axis of the optical system.

Here, it is preferable to further include a reference image generation unit which generates a reference image from the image captured by the imaging device without the birefringence effect of the optical element, in which the distance measurement unit estimates the point spread function and measure the distance to the object, using the reference image and the image captured through the optical element.

Here, it is preferable that the reference image generation unit generates an all-in-focus image as the reference image from the image captured by the imaging device without the birefringence effect of the optical element.

Here, it is preferable that the optical system has an optical property of image-space telecentricity.

Here, a light beam splitting unit which splits a light beam into light beams in a plurality of optical paths may further be included. The imaging device may include a plurality of imaging devices, and each of the imaging devices may capture the object according to a corresponding one of the optical paths resulting from the splitting by the light beam splitting unit, and the optical element may be placed on at least one of the optical paths resulting from the splitting by the light beam splitting unit.

Note that the present invention can be implemented not only as such an imaging apparatus, but also an imaging method including steps of operations of the characteristic elements included in the imaging apparatus. In addition, the present invention can be implemented as a program for causing a computer to execute the imaging method. Such a program can be distributed via a recording medium such as a CD-ROM, or a transmission medium such as the Internet. Furthermore, the present invention can be implemented as an integrated circuit which performs processing of each processing unit.

### ADVANTAGEOUS EFFECTS OF INVENTION

The imaging apparatus according to the present invention calculates a form of a PSF included in an image by using at least two images, one of which is the image including the PSF, thereby allowing stable and highly-accurate determination of an object distance.

### BRIEF DESCRIPTION OF DRAWINGS

FIG. 1 is a block diagram showing a configuration of an imaging apparatus according to Embodiment 1 of the present invention.

FIG. 2 is a diagram showing transmission of a light beam passing through a birefringent substance.

FIG. 3 is a diagram showing an arrangement of elements of the imaging apparatus according to Embodiment 1 of the present invention.

FIG. 4 is a diagram showing a change in form of PSF due to the birefringent substance between positions in front of and behind the image point corresponding to an object distance.

In FIG. 5, (a-1) is a diagram showing a form of the PSF of the extraordinary ray at a position (a) in FIG. 4 when the birefringent substance is used; (b-1) is a diagram showing a form of the PSF of the extraordinary ray at a position (b) in FIG. 4 when the birefringent substance is used; (a-2) is a diagram showing a form of the PSF at the position (a) in FIG. 4 when the birefringent substance is not used; (b-2) is a diagram showing a form of the PSF at the position (b) in FIG. 4 when the birefringent substance is not used.

FIG. 6 is a diagram showing PSFs each corresponding to a different position of the object when the birefringent substance is used.

FIG. 7 is a diagram showing PSFs each corresponding to a different position of the object when the birefringent substance is not used.

FIG. 8 is a diagram showing a form of a cubic phase mask.

FIG. 9 is a block diagram showing an operational flow of the imaging apparatus according to Embodiment 1 of the present invention.

FIG. 10 is a block diagram showing a configuration of an imaging apparatus according to Embodiment 2 of the present invention.

FIG. 11 is a diagram showing an arrangement of elements of the imaging apparatus according to Embodiment 2 of the present invention.

### DESCRIPTION OF EMBODIMENTS

Hereinafter, embodiments of the present invention are described with reference to the drawings. Note that the embodiments described as follows show preferred exemplary embodiments of the present invention. Elements, arrangement positions and connection conditions of those elements, and orders of operations described in the embodiments below are merely examples, and they are not intended to limit the present invention. The present invention is only defined by the scope of the claims. Therefore, the elements in the below-described embodiments but not described in the independent claims showing the most generic concepts are not always necessary to achieve the problems of the present invention, but they are described as elements configuring more preferred embodiments.

### Embodiment 1

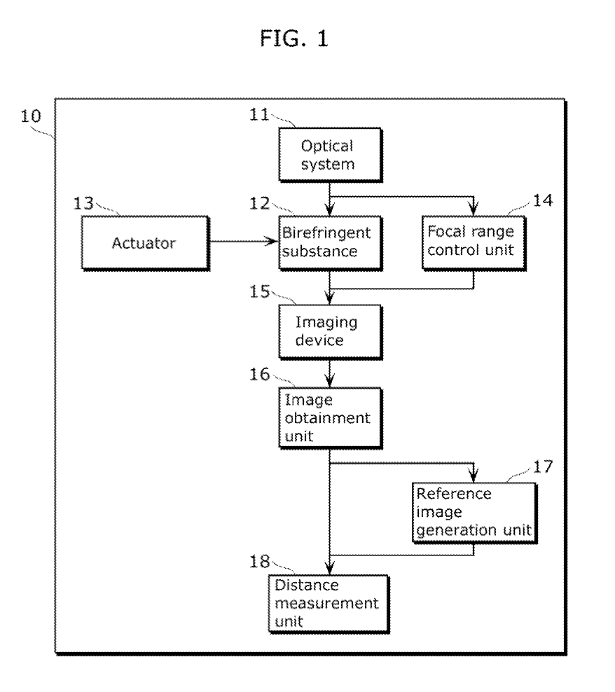

FIG. 1 is a block diagram showing a configuration of an imaging apparatus according to Embodiment 1 of the present invention.

An imaging apparatus 10 includes: an optical system 11, a birefringent substance 12, an actuator 13, a focal range control unit 14, an imaging device 15, an image obtainment unit 16, a reference image generation unit 17, and a distance measurement unit 18.

In FIG. 1, the optical system 11 forms an image of an object on the imaging device 15. The birefringent substance 12 which is an optical element having a birefringence effect is placed on the optical path between the imaging device 15 and the optical system 11. Of the light beams which have passed through the birefringent substance 12, the form of the PSF of especially an extraordinary ray is changed. The form of the PSF is changed between positions in front of and behind the image point corresponding to the object distance. The actuator 13 inserts or retracts the birefringent substance 12 with respect to the optical path. Since the actuator 13 inserts or retracts the birefringent substance 12 with respect to the optical path, the imaging apparatus 10 can obtain an image of the object captured through the birefringent substance 12 and an image of the object captured without the birefringent substance 12. The focal range control unit 14 moves at least one of the optical system 11 and the imaging device 15 to control a focal position and a depth of field. Specifically, the focal range control unit 14 performs the control by causing the optical system 11 to operate in a specific pattern, or switching a specific optical element. The imaging device 15 is made up of a CCD, a CMOS, and so on, and converts the light received on the imaging area to an electric signal for each pixel and output the electric signal. The image obtainment unit 16 obtains a plurality of images from the imaging device 15 and holds each of the images. The reference image generation unit 17 generates a reference image (all-in-focus image) in which a state of no blur derived from the optical system is estimated, from a plurality of images each of which has a different focal position and a depth of field and which is obtained with the effect of the focal range control unit 14. The distance measurement unit 18 uses the blurred image which is focused on any of the distances and the reference image obtained from the reference image generation unit 17 to measure a distance based on the method of the DFD.

Next, described is a method of changing, by the birefringent substance 12, a form of a PSF between positions in front of and behind the image point corresponding to the object distance.

The birefringent substance 12 is a substance having optical anisotropy, and has a property of separating a light beam into an ordinary ray and an extraordinary ray according to a polarization direction of the light beam entering the substance. The ordinary ray and the extraordinary ray are determined according to a direction of an optic axis (optic axis of a crystal) specific to the birefringent substance 12. The ordinary ray is a ray having an electric field oscillating perpendicular to a plane formed by the optic axis and the incident light beam. The extraordinary ray is a ray having an electric field oscillating within the plane. Note that the direction and the number of the optic axis changes depending on types of the substance. When the substance has one optic axis, it is called uniaxial, and when the substance has two optic axes, it is called biaxial. In Embodiment 1, calcite which is a uniaxial crystal is used as the birefringent substance 12.

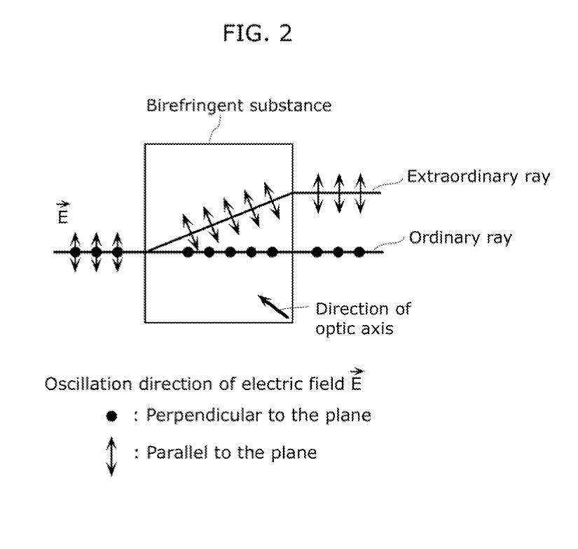

The difference between the ordinary ray and the extraordinary ray is that when those rays pass through the birefringent substance 12, the speed of the ordinary ray is constant regardless of the direction of propagation of the ordinary ray. On the other hand, the speed of the extraordinary ray varies depending on the direction of propagation of the extraordinary ray. In addition, a refractive index “no” for the ordinary ray and a refractive index “ne” for the extraordinary ray are different. Because of the difference between the refractive index “no” for the ordinary ray and the refractive index “ne” for the extraordinary ray, and the property of varying the speed of the extraordinary ray depending on the direction of propagation of the ray, when the light beam enters the birefringent substance 12, the travelling direction differs between the ordinary ray and the extraordinary ray as shown in FIG. 2. Therefore, the light beam which has entered the birefringent substance 12 is separated into the ordinary ray and the extraordinary ray in the birefringent substance 12. In FIG. 2, the light beam enters perpendicular to the plane of the birefringent substance 12 from the left side of the birefringent substance 12.

The present invention uses especially the extraordinary ray to change the form of the PSF between the positions in front of and behind the image point corresponding to the object distance.

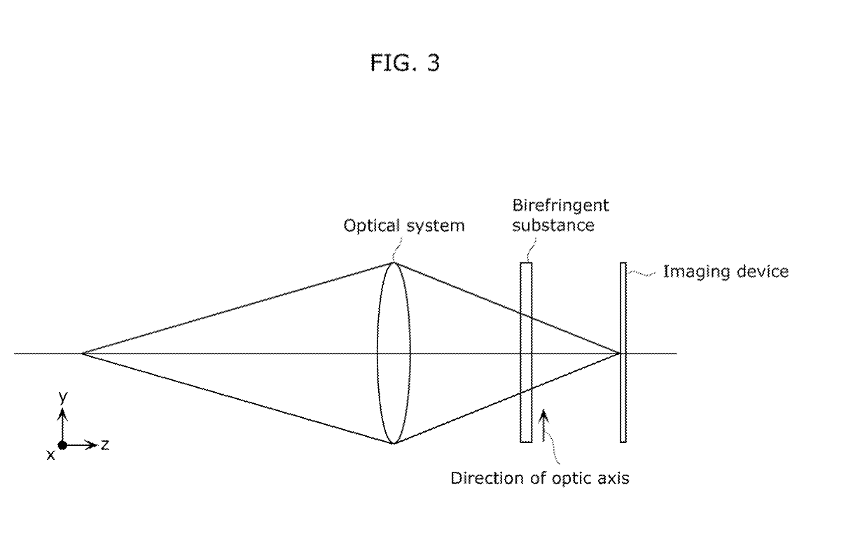

The positional relationship among the optical system 11, the birefringent substance 12, and the imaging device 15 is shown in FIG. 3. The birefringent substance 12 is placed between the optical system 11 (lens) and the imaging device 15. In other words, these three elements are aligned on the light axis in the order of the optical system 11, the birefringent substance 12, and the imaging device 15. The birefringent substance 12 is a parallel plate which is formed and placed such that all of the planes which intersect with the light axis are perpendicular to the light axis. Note that the “perpendicular” in this case may not be exactly perpendicular. In addition, the birefringent substance 12 is uniaxial, and the optic axis is in the y-direction in FIG. 3. Note that the relationship of the refractive indices is no>ne between the ordinary ray and the extraordinary ray. Here, the positional relationship among the optical system 11, the birefringent substance 12, and the imaging device 15 is described, but the birefringent substance 12 is desirably a parallel plate for obtaining an advantageous effect with the above-described positional relationship. If the birefringent substance 12 is a parallel plate, the birefringent substance 12 has a property of only affecting astigmatism in general. The parallel plate mentioned here is a substance having a first surface and a second surface parallel to each other. Here, the first surface is the side where the light enters, and the second surface is the side where the light exits. That is, the angles and the forms of the surfaces other than the first surface and the second surface are not limited.

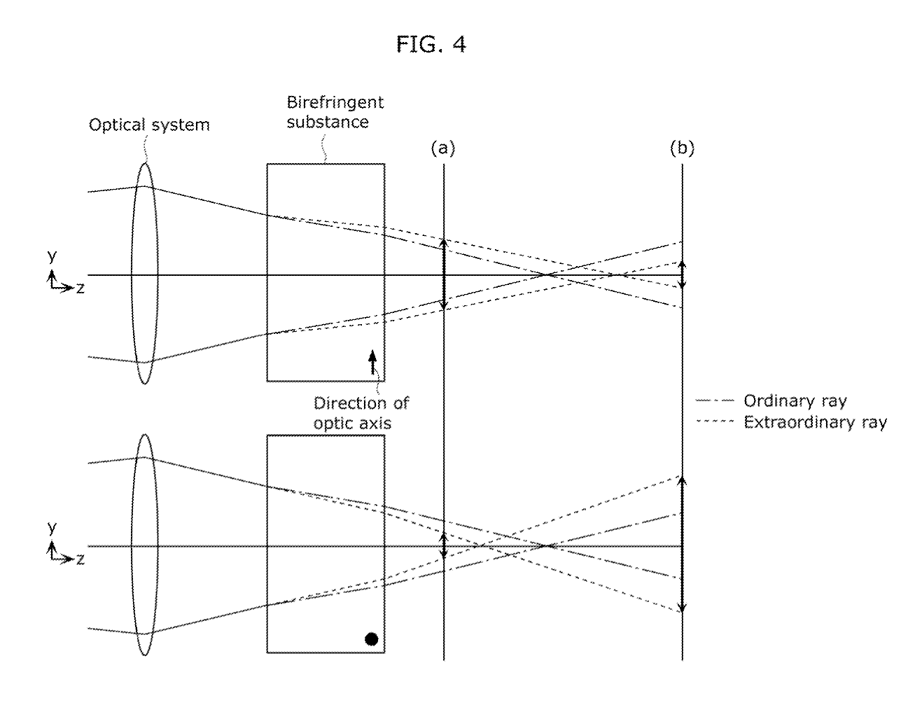

Use of the configuration in FIG. 3 changes the form of the PSF of the extraordinary ray between positions in front of and behind the image point corresponding to the object distance. The PSF at a position in front of the image point corresponding to the object distance has a form which is longer in y-direction, and the PSF at a position behind the image point corresponding to the object distance has a form which is longer in x-direction. FIG. 4 is a diagram showing behaviors of the ordinary ray and the extraordinary ray on the y-z plane and the x-z plane in the configuration in FIG. 3. On the y-z plane, the extraordinary ray refracts more strongly than the ordinary ray and the position of the image point corresponding to the object distance is farther than that in the case of the ordinary ray, due to the property that the speed of the extraordinary varies depending on the direction of the optic axis and the propagation direction of the extraordinary ray. On the other hand, on the x-z plane, the extraordinary ray has a smaller refractive angle than that of the ordinary ray, and the position of the image point corresponding to the object distance is closer than that in the case of the ordinary ray. When only the extraordinary ray is considered, the position of the image point corresponding to the object distance differs between the ray on the x-z plane and the ray on the y-z plane. Therefore, the form of the PSF of the extraordinary ray at the position (a), which is the position in front of the image point corresponding to the object distance in FIG. 4, is longer in the y-direction as shown in (a-1) of FIG. 5, because the blurring in the y-direction is larger than that in the x-direction. On the other hand, the form of the PSF of the extraordinary ray at the position (b) which is the position behind the image point corresponding to the object distance is longer in the x-direction as shown in (b-1) of FIG. 5, because the blurring in the x-direction is larger than that in the y-direction. Moreover, (a-2) and (b-2) of FIG. 5 respectively show the PSF of the ordinary ray at the position (a) and that at the position (b) in FIG. 4. These may be referred to as the PSFs of the rays without the birefringent substance 12. That is, when there is no birefringent substance 12, the forms of the PSFs are similar (for example, circular forms in this case) between the positions in front of and behind the image point corresponding to the object distance.

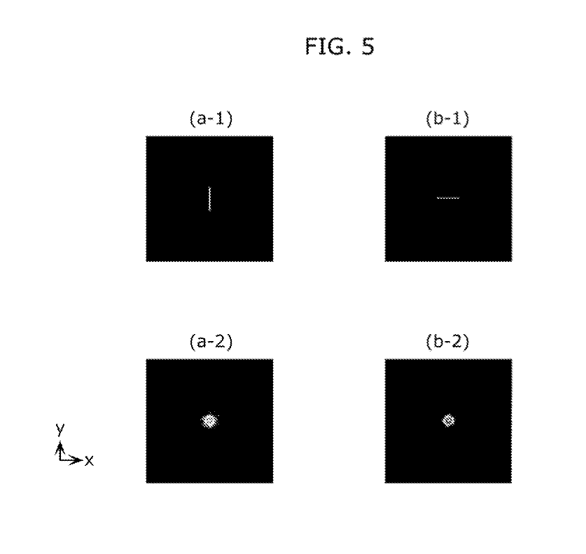

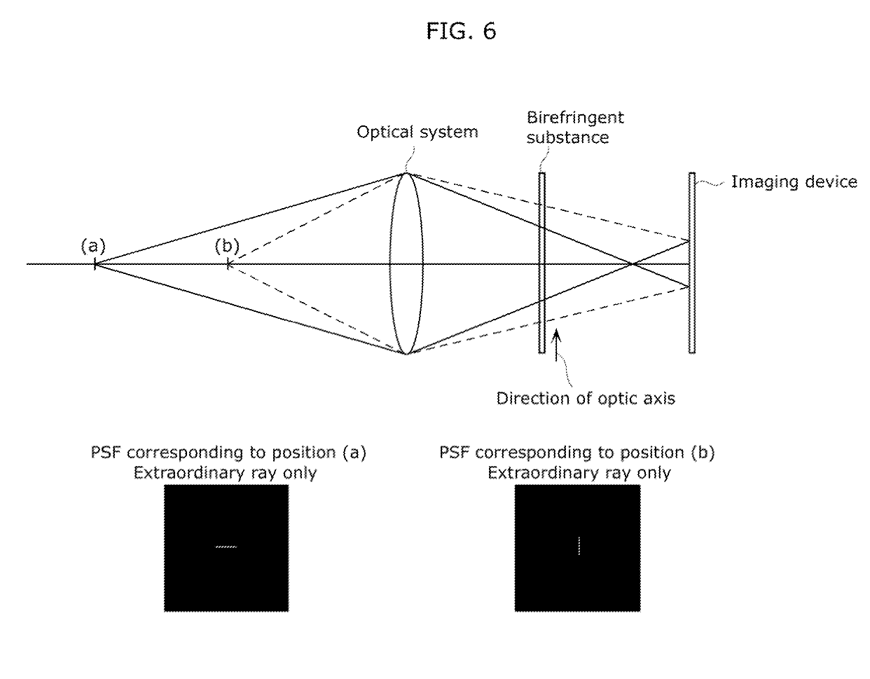

Difference in form of the PSF between the positions in front of and behind the image point corresponding to the object distance eliminates the ambiguity in determination of the distance, thereby allowing unambiguous estimation of the object distance. Hereinafter, a description is given based on FIGS. 6 and 7 about effectiveness of the estimation of the object distance when the birefringent substance is used. Note that FIG. 6 is a diagram showing PSFs each corresponding to a different position of the object when the birefringent substance 12 is used. FIG. 7 is a diagram showing PSFs each corresponding to a different position of the object when no birefringent substance 12 is used. The “object distance” referred here is previously defined as the distance from the imaging apparatus to the object, but it may be the distance from the optical system 11 to the object, or the distance from the imaging device 15 to the object.

When the birefringent substance 12 is used as in FIG. 6 and the PSF corresponding to the object position (a) and the PSF corresponding to the object position (b) are considered, the form of the PSF differs between the positions in front of and behind the image point corresponding to the object distance. Therefore, the form of the PSF formed on the imaging device 15 corresponding to the position (a) differs from the form of the PSF formed on the imaging device 15 corresponding to the position (b). That is, the object distance can be estimated unambiguously from the PSF obtained by the imaging device 15. On the other hand, since no birefringent substance 12 is used in FIG. 7, the forms of the PSFs corresponding to the respective positions (a) and (b) are similar. Therefore, it is ambiguous due to the noise whether the obtained PSF corresponds to the position (a) or (b), thereby making it difficult to unambiguously estimate the object distance. That is, when the birefringent substance 12 is used as shown in FIG. 6, the difference of the PSFs obtained by the imaging device 15 becomes clear as to whether the obtained PSF corresponds to the position in front of or behind the image point corresponding to the object distance, compared to the case where no birefringent substance 12 is used as in FIG. 7. Therefore, the object distance can be easily estimated unambiguously, and the use of the birefringent substance 12 is effective in this regard. Note that the calculation of the PSF in FIGS. 5 to 7 uses “ZEMAX” (trade name) which is optical simulation software available from ZEMAX Development Corporation.

In practice, the ordinary ray and the extraordinary ray are detected simultaneously in the configuration in FIG. 3. Since the extraordinary ray is included, the form of the PSF still differs between the positions in front of and behind the image point corresponding to the object distance.

Next, a method of obtaining a reference image is described.

The imaging apparatus 10 according to Embodiment 1 uses a reference image (all-in-focus image) having no blur derived from the optical system 11. The image having no blur derived from the optical system 11 may also be referred to as an image having a deep depth of field. The depth of field can be easily deepened by narrowing the aperture of the optical system. However, the amount of light to be received by the imaging device 15 is decreased with this method. To solve this problem, techniques have been suggested for deepening the depth of field without narrowing the aperture. One of the techniques is called Extended Depth of Field (hereinafter, referred to as EDoF). Hereinafter, specific techniques of EDoF are described.

The simplest technique of EDoF is to capture a plurality of images while the focal position is gradually shifted during the capture, extract the focused parts from the obtained images, and combine them.

In contrast, Non-patent Literature (NPL) 2 discloses a technique of changing the focal position during exposure, and generating an image having no blur.

Specifically, moving the imaging device or the lens in the direction of the light axis during the exposure allows the PSFs to be almost constant regardless of the object distance, and a uniformly blurred image can be obtained. Performing deconvolution by using the PSF which is constant and free from the influence of the object distance makes it possible to obtain an image entirely having no blur.

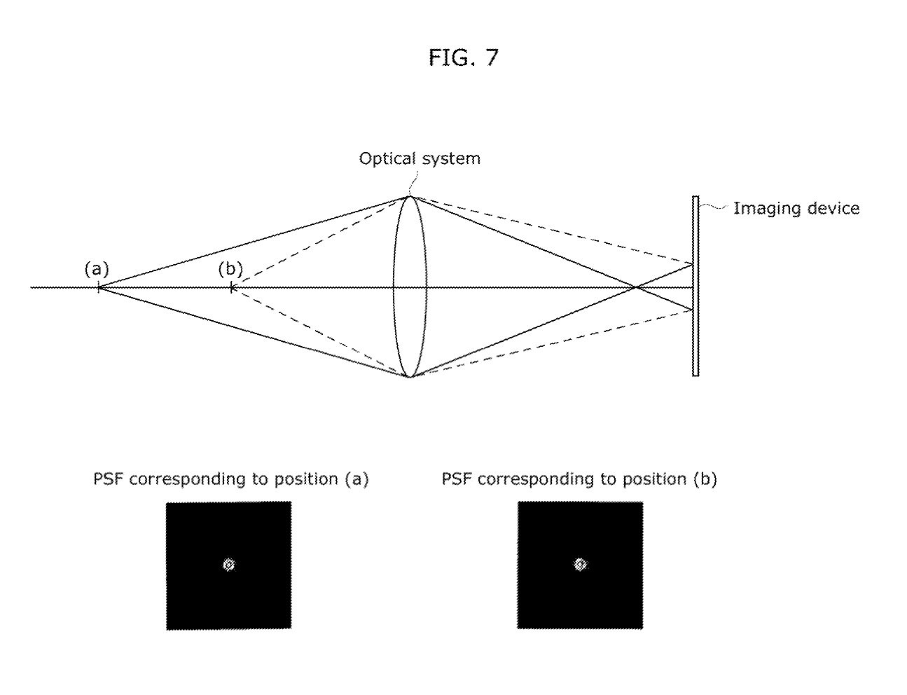

On the other hand, a technique for EDoF using a special optical element is also suggested. One example is a method of using an optical element called a cubic phase mask. One example of the form of the cubic phase mask is shown in FIG. 8. Incorporating an optical element having this kind of form near the aperture of the optical system allows generation of an image having a uniform blur regardless of the object distance. Deconvolution by using the PSF which is constant and free from the influence of the object distance as in Non-patent Literature 1 makes it possible to obtain the image entirely having no blur. A method of using a multifocal lens and the like may also be used.

Note that a method of changing the focal position during the exposure time is used in the following description as a technique for obtaining a reference image by extending the depth of field.

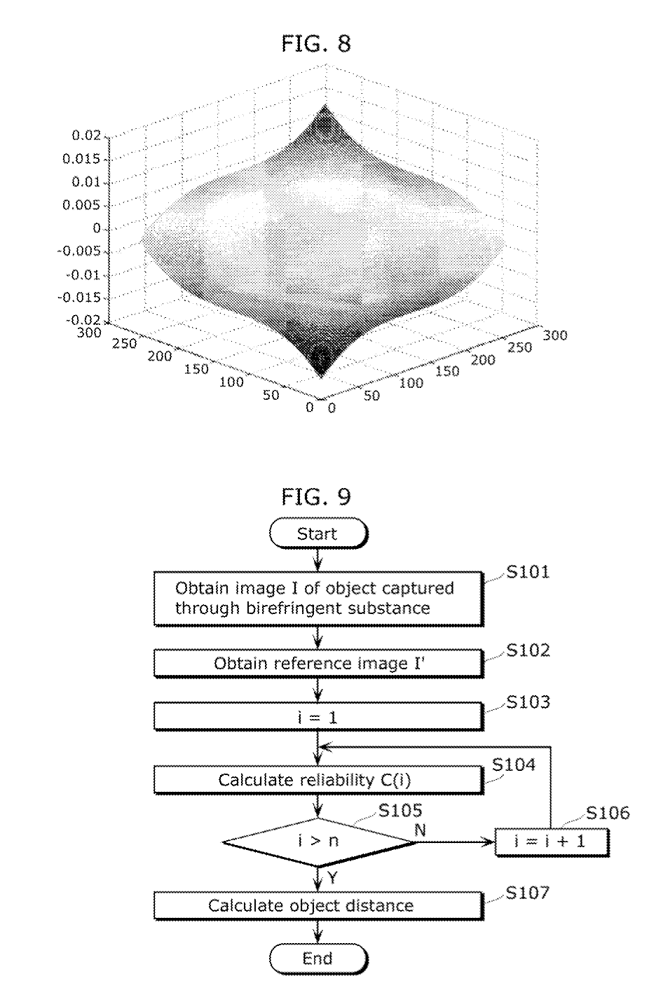

Next, a flow of the process of calculating the object distance is described. FIG. 9 is a flowchart showing an example of the flow of process of calculating the object distance. This process is to calculate which one of predetermined n-stages of object distances d1, d2, . . . , dn is closest to a distance to a target object by using a captured image of the target object.

First, an image I which is an image of the object captured through the birefringent substance, and a reference image I′ are obtained (Step S101 and Step S102). Note that the order of Step S101 and Step S102 may be reversed. Here, the reference image obtained here is an image of the object captured without the birefringent substance 12.

Here, the relationship expressed in Math 1 shown below is established between the image I and the reference image I′.

[Math. 1]

I(x,y)=I′(x,y)*h(x,y,d(x,y)) Expression 1

Here, h represents the PSF at a position (x, y) in the image, and d(x, y) represents the object distance at the position (x, y). In addition, * in the expression represents the convolution operation. The PSF differs depending on the object distance. Therefore, when objects are at different distances, the PSFs each having a different object distance at its corresponding position in the image is convoluted into an image having no blur to obtain the image I.

Next, an initial value 1 is substituted into a counter i (Step 103), and an error function C(x, y, di) for the object distance at an i-th stage is calculated for each pixel in the image (Step S104). The error function is expressed in Math 2 shown below.

[Math. 2]

C(x,y,dᵢ)=|(x,y)−I′(x,y)*h(x,y,dᵢ)| (i=1,2, . . . , n) Expression 2

Here, h(x, y, di) represents the PSF corresponding to the object distance di. The PSF corresponding to the object distance di (i=1 to n, where n is a natural number of 2 or more) is stored in advance in the memory in the imaging apparatus 10, for example. Expression 2 corresponds to calculating difference between the actually-captured image I and the image obtained by convoluting the PSF h(x, y, di) corresponding to the object distance di at the i-th stage into the reference image I′ having no blur. When the captured object is actually present at the i-th stage, the value of the error function C(x, y, di) is minimum, which is the difference between the image I and the reference image I.

The error function C(x, y, di) in Expression 2 is an absolute value of the difference between the actually-captured image I and the image obtained by convoluting, for each pixel, the PSF h(x, y, di) corresponding to the object distance di at the i-th stage into the image having no blur. The error function may also be obtained based on any form representing the distance, such as the L2 norm.

When the error function is calculated, it is determined whether the value of the counter i reaches n (Step S105). When the value of the counter i does not reach n, the value of the counter i is incremented by 1 (Step S106), and this process is repeated until the value of the counter i reaches n.

When all of the error functions from the first stage to the stage n are calculated, the object distance is calculated (Step S107). The object distance d(x, y) at the position (x, y) is expressed in Expression 3 shown below.

$$\begin{matrix}[ Math . 3 ] & \\ d ( x , y ) = {arg min}_{di} C ( x , y , {d}_{i} ) & Expression 3\end{matrix}$$

In practice, to reduce influence of a noise included in the captured image I, for example, the image is divided into blocks and the sum of the error functions of the blocks is obtained, and the object distance having the minimum error function is set to the distance of the object captured in the blocks as a whole. This process enables more stable distance measurement.

According to the above configuration, since the form of the PSF differs between the positions in front of and behind the image point corresponding to the object distance, the object distance can be estimated unambiguously.

In this embodiment, the direction of the optic axis of the birefringent substance 12 is upward in FIG. 3, but it is not limited to the upward direction and may be any of the directions. Even when a direction other than upward is used, the form of the PSF may be changed between positions in front of and behind the image point corresponding to the object distance. Change in the direction of the optic axis also changes the form of the PSF to be obtained. Regardless of the direction of the optic axis, the position of the image point corresponding to the object distance resulting from the ordinary ray differs from the position of the image point corresponding to the object distance resulting from the extraordinary ray. However, the form of the PSF at the position in front of the image point corresponding to the object distance differs little from that of the PSF at the position behind the image point corresponding to the object distance, only when the optic axis and the light axis are parallel to each other. Therefore, the birefringent substance 12 is desirable to be placed such that the direction of the optic axis of the birefringent substance 12 and the light axis are not parallel to each other.

Moreover, even though it is described that calcite, a uniaxial crystal, is used as the birefringent substance 12 in this embodiment, other materials having the birefringence effect may be used. Besides the direction of the optic axis, the number of the optic axis may also be used as a factor of controlling the form of the PSF. The effect of the present invention may also be obtained by using a biaxial birefringent subtance, besides the uniaxial birefringent substance. The range of the variation may be expanded by placing a plurality of uniaxial or biaxial birefringent substances, or both of the birefringent substances. Thickness and type of the birefringent substance also changes the form of the PSF to be obtained between positions in front of and behind the image point corresponding to the object distance.

Note that in this embodiment, it is described that the image of the object captured through the birefringent substance 12 and the image of the object captured without the birefringent substance 12 may be obtained by moving the birefringent substance by the actuator. However, other methods may be used. For example, in general, the images may be obtained by (i) moving the birefringent substance into or out of the optical path by the movement of the birefringent substance itself caused by physically driving the substance, or (ii) using an optical element capable of controlling the effect of the birefringence.

In the former way (i), for example, the birefringent substance is moved lineally by the actuator or the plate of the birefringent substance is rotated while the birefringent substance held perpendicular to the light axis, thereby creating a situation where the birefringent substance is on or out of the optical path. For the latter way (ii), examples of the element include an element capable of performing electric control such as the electrooptic effect, and an element capable of performing magnetic control. In these cases, the presence or absence of the effect of the birefringence may be controlled by applying and not applying the voltage or magnetic field. In addition, instead of the birefringent substance, a material such as a liquid crystal may be used, which is a material capable of controlling the effect of the birefringent substance electrically and magnetically.

The position of the birefringent substance is not limited to the position shown in FIG. 3. Placing the birefringent substance at any position also provides the effect of changing the form of the PSF between positions in front of and behind the image point corresponding to the object distance. However, it is desirable to place the birefringent substance immediately before the imaging device as shown in FIG. 3 because a more significant effect can be obtained.

Note that the optical system 11 is desirable to be an optical system in which forms of PSFs are the same at all of the image heights. In particular, the optical system 11 is desirable to be an image-space telecentric optical system. The image-space telecentric optical system is an optical system in which the principle light beam and the light axis are parallel to each other at all of the image angles in the image space. In the configuration in FIG. 3, use of the image-space telecentric optical system as the optical system 11 makes the forms of the PSFs at all of the image heights the same, even if the birefringent substance 12 is placed on the optical path. In other words, if the optical system has the property of having the same form of the PSF at all of the image heights, this property is retained even when the birefringent substance 12 is placed on the optical path. Therefore, in this case, the optical system does not need to be re-designed to include the birefringent substance. If the optical system has the property of having the same form of the PSFs at all of the image heights, use of a single PSF for the computation of the distance measurement may be sufficient, and the cost to be incurred in the computation can be suppressed.

### Embodiment 2

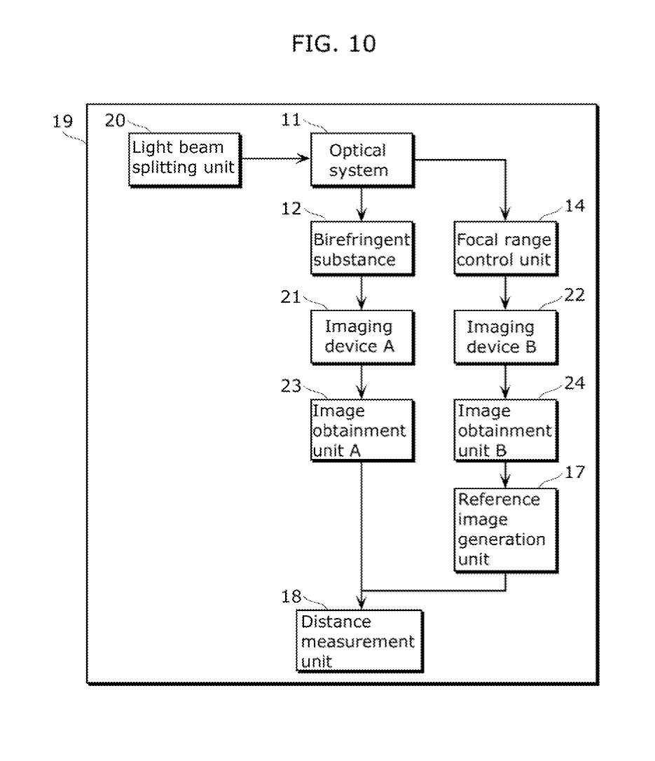

An imaging apparatus 19 according to Embodiment 2 of the present invention has a configuration of splitting the ordinary ray and the extraordinary ray, and obtaining an image including only the ordinary ray and an image including only the extraordinary ray. FIG. 10 is a block diagram showing the configuration of the imaging apparatus 19 according to Embodiment 2 of the present invention. In FIG. 10, the same reference numbers are used for the elements same as in the imaging apparatus 10 in FIG. 1, and some of the descriptions of the elements are omitted. The imaging apparatus 19 includes: the optical system 11, a light beam splitting unit 20, the birefringent substance 12, the focal range control unit 14, an imaging device A21, an imaging device B22, an image obtainment unit A23, an image obtainment unit B24, the reference image generation unit 17, and the distance measurement unit 18.

In FIG. 10, the optical system 11 forms an image of an object on each of the imaging device A21 and the imaging device B22. The light beam splitting unit 20 spatially splits the light beam at any ratio of the amounts of light. The imaging device A21 and the imaging device B22 are each made up of a CCD, a CMOS, and so on, and the imaging devices A21 and B22 convert the light received on the imaging area into an electric signal for each pixel, and output the signal. In addition, the form of the PSF of one of the light beams split by the light beam splitting unit 20 is changed by the birefringent substance 12, and the one of the light beams is received by the imaging device A21. The imaging device B22 receives the other light beam split by the light beam splitting unit 20. The other light beam is a light beam which has not passed through the birefringent substance 12, and thus does not have any influence of the birefringent substance 12. The image obtainment unit A23 and the image obtainment unit B24 obtain images from the imaging device A21 and the imaging device B22, respectively, and store the obtained images.

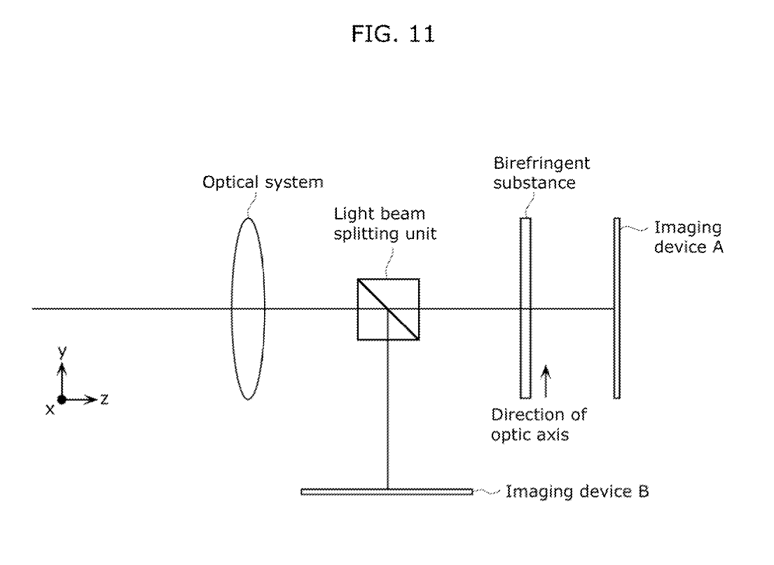

More specifically, the imaging apparatus has a configuration as shown in FIG. 11, and the imaging device A21 obtains the blurred image including a PSF of which form is changed by the birefringent substance 12 between positions in front of and behind the image point corresponding to the object distance. On the other hand, the light beam which does not pass through the birefringent substance 12 is captured by the imaging device B22 when its focal position and the depth of field are controlled by the focal range control unit 14 in the same manner as Embodiment 1. Then, the reference image generation unit 17 generates a reference image based on the image obtained by the imaging device B22. The blurred image obtained by the imaging device A21 and the reference image generated from the image obtained by the imaging device B22 are used for the calculation of the object distance by performing the same process as shown in FIG. 9. The blurred image obtained by the imaging device A21 and the reference image obtained by the reference image generation unit 17 respectively correspond to the image I and the reference image I′ in FIG. 9. Moreover, the object distance can be calculated by the same calculation as in Expressions 1 to 3.

Examples of the light beam splitting unit 20 used for splitting the light beam include an unpolarized beam splitter and a polarized beam splitter. When the unpolarized beam splitter is used, the image I to be obtained includes both of the extraordinary ray and the ordinary ray as in Embodiment 1. When the polarized beam splitter is used, the image I only including the extraordinary ray can be obtained by controlling the optic axis of the birefringent substance and the direction of the polarization. Limiting the light beam included in the image Ito the extraordinary ray allows an image to be captured without a noise caused by the ordinary ray. Therefore, a more accurate image for deriving the object distance can be obtained. In addition, when the polarized beam splitter is used, the birefringent substance may also be placed between the polarized beam splitter and the optical system. In this case, the polarization direction needs to be selected such that only the ordinary ray reaches the imaging device B22.

Note that the image only including the extraordinary ray can also be obtained by only transmitting the extraordinary ray by using the optical element that only transmits a specific polarization such as a polarizer, although the amount of light in such an image decreases.

According to the above configuration, the image I and the reference image I′ can be obtained at the same time, and no difference other than the blur is generated in both of the images. Therefore, the object distance can be obtained more accurately. In the configuration in Embodiment 1, the image I and the reference image I′ are not obtained at the same time. Thus the relative position of the object with respect to the imaging apparatus may change due to the motion of the object and the imaging apparatus itself, and differences other than the blur are generated in both of the images and the accuracy of the distance measurement is likely to be degraded. However, if the capturing time for one image is the same, the amount of light entering one imaging device becomes larger in Embodiment 1 because the light beam is not split, and thus a signal-to-noise ratio (S/N ratio) is larger in Embodiment 1.

The image I and the reference image I′ are obtained in Embodiment 1 by temporally separating the functions of the imaging apparatus, while the image I and the reference image I′ are obtained in Embodiment 2 by spatially separating the functions of the imaging apparatus. Since the light beam is split in Embodiment 2, the amount of light for each of the image I and the reference image I′ is decreased, but the total amount of the light of both of the images is not decreased, and thus the amount of light is not wasted. If the time required for obtaining both of the images are the same in Embodiment 1 and Embodiment 2, the total amount of light is the same in Embodiment 1 and Embodiment 2.

Note that in Embodiment 1 and Embodiment 2, an all-in-focus image is used as the reference image to obtain the object distance, but it is not limited to this. An image having a uniform blur may be used as the reference image to derive the object distance.

Note that an LSI which is an integrated circuit may be usually used for a control unit of the actuator 13 which is a birefringence effect providing unit, the image obtainment unit 16 which is an imaging unit, and the distance measurement unit 18 among functional blocks in the block diagrams (such as FIG. 1 and FIG. 10) in the previously-described Embodiment 1 and Embodiment 2. Each of these elements may be integrated into a separate single chip, or some or all of them may be integrated into a single chip. All the functional blocks other than the memory may be integrated into a single chip, for example.

Although the integrated circuit is here referred to as an LSI, it may be referred to as an IC, a system LSI, a super LSI or an ultra LSI, depending on the degree of integration.

The method of forming integrated circuitry is not limited to use of LSIs. Dedicated circuitry or a general-purpose processor may be used instead of LSIs. Also applicable is a field programmable gate array (FPGA), which allows post-manufacture programming, or a reconfigurable processor LSI, which allows post-manufacture reconfiguration of connection and setting of circuit cells therein.

Furthermore, in the event that an advance in or derivation from semiconductor technology brings about an integrated circuitry technology whereby an LSI is replaced, the functional blocks may be obviously integrated by using such new technology. The adaptation of biotechnology or the like is possible.

Among the functional blocks, only a unit for storing data to be processed may be excluded from integration into a single chip and configured otherwise.

### INDUSTRIAL APPLICABILITY

The imaging apparatus according to the present invention can measure a distance based on the image captured from a single viewpoint, and thus the present invention can be applied to general imaging apparatuses.

### REFERENCE SIGNS LIST

10 Imaging apparatus
11 Optical system
12 Birefringent substance
13 Actuator
14 Focal range control unit
15 Imaging device
16 Image obtainment unit
17 Reference image generation unit
18 Distance measurement unit
19 Imaging apparatus
20 Light beam splitting unit
21 Imaging device A
22 Imaging device B
23 Image obtainment unit A
24 Image obtainment unit B

1-13. (canceled)

14. An imaging apparatus comprising:
an imaging device which captures an image;
an optical system for forming an image of an object on the imaging device;
an optical element having a birefringence effect; and
a distance measurement unit configured to measure a distance from the imaging device to the object, using the captured image and a point spread function having a form changed by the optical element between positions in front of and behind an image point corresponding to the distance to the object.

15. The imaging apparatus according to claim 14,
wherein the optical element has an optic axis of which a direction is not parallel to a light axis of the optical system.

16. The imaging apparatus according to claim 14,
wherein the optical element is placed between the imaging device and the optical system on the light axis of the optical system, and a plane of the optical element which intersects with the light axis of the optical system is perpendicular to the light axis of the optical system.

17. The imaging apparatus according to claim 14, further comprising
an optical element moving unit configured to turn on or off the birefringence effect on the light axis of the optical system by inserting or retracting the optical element with respect to the light axis of the optical system,
wherein the distance measurement unit is configured to measure the distance from the imaging device to the object, using an image captured by the imaging device without the birefringence effect of the optical element and using an image captured with the optical element placed on the light axis of the optical system.

18. The imaging apparatus according to claim 14,
wherein the optical element is configured to turn on or off the birefringence effect electrically or magnetically, and
the distance measurement unit is configured to measure the distance to the object, using the image captured by the imaging device without the birefringence effect of the optical element and using an image captured with the optical element placed on the light axis of the optical system.

19. The imaging apparatus according to claim 14, further comprising
a reference image generation unit configured to generate a reference image from the image captured by the imaging device without the birefringence effect of the optical element,
wherein the distance measurement unit is configured to estimate the point spread function and measure the distance to the object, using the reference image and the image captured through the optical element.

20. The imaging apparatus according to claim 19,
wherein the reference image generation unit is configured to generate an all-in-focus image as the reference image from the image captured by the imaging device without the birefringence effect of the optical element.

21. The imaging apparatus according to claim 14,
wherein the optical system has an optical property of image-space telecentricity.

22. The imaging apparatus according to claim 14, further comprising
a light beam splitting unit configured to split a light beam into light beams in a plurality of optical paths,
wherein the imaging device includes a plurality of imaging devices, and each of the imaging devices captures the object according to a corresponding one of the optical paths resulting from the splitting by the light beam splitting unit, and
the optical element is placed on at least one of the optical paths resulting from the splitting by the light beam splitting unit.

23. The imaging apparatus according to claim 14,
wherein the optical element includes a plurality of optical elements.

24. An imaging method for an imaging apparatus including an imaging device which captures an image and an optical system for forming an image of an object on the imaging device, the method comprising:
providing a birefringence effect on a light axis of the optical system, the birefringence effect changing a form of a point spread function determined by the optical system, between positions in front of and behind an image point corresponding to a distance to the object;
capturing an image by the imaging device with the birefringence effect provided on the light axis of the optical system; and
measuring the distance to the object, using the point spread function and the image captured by the imaging device.

25. A non-transitory computer-readable recording medium for use in a computer, the recording medium having a computer program recorded thereon for causing a computer to execute the imaging method according to claim 24.

26. An integrated circuit of an imaging apparatus including an imaging device which captures an image and an optical system for forming an image of an object on the imaging device, the integrated circuit comprising:
a birefringence effect providing unit configured to provide an birefringence effect on the light axis of the optical system, the birefringence effect changing a form of a point spread function determined by the optical system, between positions in front of and behind an image point corresponding to a distance to the object;
an imaging unit configured to cause the imaging device to capture an image with the birefringence effect provided on the light axis of the optical system; and
a distance measurement unit configured to measure the distance to the object, using the point spread function and the image captured by the imaging device.
